(19) United States
(12) Patent Application Publication
(10) Pub. No.: US 2009/0265714 A1
(43) Pub. Date: Oct. 22, 2009

(54) DIVIDED DISK COMMAND PROCESSING SYSTEM AND METHOD THEREOF

(75) Inventors: Chih-Wei CHEN, Taipei City (TW); Hsiao-Fen Lu, Taipei City (TW)

Correspondence Address: Chih Feng Yeh;BRIAN M. MCINNIS, 12th Floor, Ruttonjee House, 11 Duddell Street, Hong Kong, HK

(73) Assignee: INVENTEC CORPORATION

(21) Appl. No.: 12/140,631

(22) Filed: Jun. 17, 2008

(30) Foreign Application Priority Data
Apr. 18, 2008 (TW) 97114298

(51) Int. Cl. G06F 9/46

(52) U.S. Cl. 718/108

(57) ABSTRACT

This present invention is a divided disk command processing system and method thereof, for processing a disk command by executing the multiple computing processes of the disk command separately in multiple processing stages, to reduce frequently storing and restoring the state as context switching of a CPU. And the processing capability of the CPU in each stage is adequately employed to speed up a disk command processing.

### RELATED APPLICATIONS

This application claims priority to Taiwan Application Serial Number 97114298, filed Apr. 18, 2008, which is herein incorporated by reference.

### BACKGROUND

1. Field of Invention

The presented invention relates to a divided disk command processing system and method thereof. More particularly, the presented invention relates to a processing system and method for executing the multiple computing processes of a disk command separately in a computer system.

2. Description of Related Art

Context switching is an essential feature of multitasking operating systems. A multitasking operating system is one in which multiple processes execute on a single CPU seemingly simultaneously and without interfering with each other. Context switching can be described in slightly more detail as the kernel (i.e., the core of the operating system) performing the following activities with regard to processes (including threads) on the CPU: (1) suspending the progression of one process and storing the CPU's state (i.e., the context) for that process somewhere in memory, (2) retrieving the context of the next process from memory and restoring it in the CPU's registers and (3) returning to the location indicated by the program counter (i.e., returning to the line of code at which the process was interrupted) in order to resume the process.

Context switching is generally computationally intensive. That is, it requires considerable processor time, which can be on the order of nanoseconds for each of the tens or hundreds of switches per second. Thus, context switching represents a substantial cost to the system in terms of CPU time and can, in fact, be the most costly operation on an operating system.

Consequently, a major focus in the design of operating systems has been to avoid unnecessary context switching to the extent possible. However, this has not been easy to accomplish in practice. In fact, although the cost of context switching has been declining when measured in terms of the absolute amount of CPU time consumed, this appears to be due mainly to increases in CPU clock speeds rather than to improvements in the efficiency of context switching itself.

### SUMMARY

For this reason, this invention provides a divided disk command processing system and method thereof, processing the disk command by executing the multiple computing processes of the disk command separately. The invention utilizes the central processing unit (CPU) of a computer system to partition the disk command into several progressions. And in each progression stage, the CPU executes the computing processes being in one identical progression state in each of the progression stages. That is, to execute the disk command separately, to reduce frequently storing and restoring the state as context switching of the CPU. And the efficiency of the CPU 110 is fully utilized when computing in one progression stage, thus reducing the execution time of a disk command.

The primary idea of the invention is to provide a divided disk command processing system, comprising: a CPU providing a plurality of progression stages to partition a disk command into multiple computing processes and separately executing the computing processes in the progression stages to execute the disk command; a command queuing unit stringing up and queuing each computing process of the disk command respectively into the corresponding progression stage to become a processing queue in the progression stage for the CPU to execute; and a queue checking unit checking all processing queues in each of the progression stages to find the processing queue which have not been computed, and informing the CPU to compute the processing queue.

The secondary idea of the invention is to provide a divided disk command processing method, comprising following steps: (a) providing a plurality of progression stages; (b) partitioning a disk command into multiple computing processes; (c) stringing up and queuing the computing processes of the disk command respectively into the corresponding progression stage to become a processing queue in the progression stage; (d) executing the computing process of the processing queue which is queued in the progression stage; (e) checking one of the progression stages to find if all the processing queues in the progression stage have been executed; and (f) shifting from the progression stage to a next progression stage.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is the block diagram of the preferred embodiment of the divided disk command processing system of this invention; and

FIG. 2 is a flowchart illustrating steps of the divided disk command processing method of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

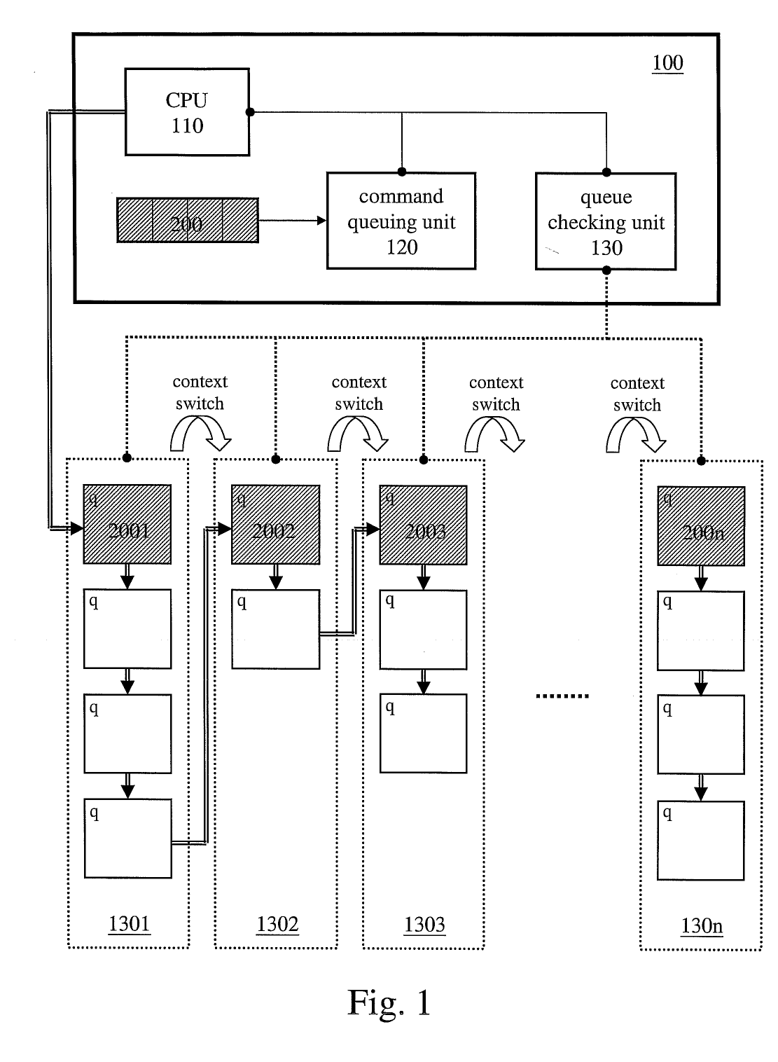

Refer to FIG. 1. FIG. 1 is the block diagram of the preferred embodiment of the divided disk command processing system of this invention. As shown in FIG. 1, the divided disk command processing system 100 comprises a CPU 110, a command queuing unit 120, and a queue checking unit 130. The CPU 110 is a central processing unit of a computer system, providing a plurality of progression stages, 1301˜130n, according to the multiple computing processes of a disk command 200, and partitioning a disk command 200 into computing processes, 2001˜200n. The CPU 110 executes the computing process 2001˜200n being in one identical progression state in each of the progression stage 1301˜130n, and by executing the computing process 2001˜200n in the progression stage 1301˜130n separately to execute the disk command 200. The command queuing unit 120 strings up and queues each computing process 2001˜200n of the disk command respectively into the corresponding progression stage 1301˜130n to become a processing queue “q” in the progression stage 1301˜130n for the CPU 110 to execute. The queue checking unit 130 checks all processing queues in each of the progression stages 1301˜130n to find the processing queue “q” which has not been computed, and informs the CPU 110 to compute the processing queue “q”. After all processing queues “q” queued in the progression stage 1301˜130n have been computed, the CPU then shifts from the progression stage to a next progression stage to compute all processing queues “q” queued in the next progression stage.

Wherein the multiple computing process 2001˜200n of the disk command 200 being executed by the CPU 110 from one computing process to next computing process, the CPU 110 has to conduct a context switch. The context switch connotes the CPU suspending progression of executing one process and resuming progression of executing other process that had previously been suspended. Therefore, by the invention, the command queuing unit 120 strings up and queues the computing process 2001˜200n of the disk command 200 respectively into the corresponding progression stage 1301˜130n to become a processing queue “q” in the progression stage 1301˜130n. For example, firstly strings up and queues the computing process, “Read Disk”, into one progression stage and strings up and queues the computing process, “Write Disk”, into another progression stage by the command queuing unit 120. And then, the CPU 110 executes all the computing processes of one identical progression state of the processing queue “q” queued in the progression stage. And when the CPU 110 shifts progression stages, the context switch is conducted only once by the CPU 110. Thus reducing frequently storing and restoring the state as context switching of the CPU 110, and the efficiency of the CPU 110 is fully utilized when computing in one progression stage to reduce the execution time of a disk command.

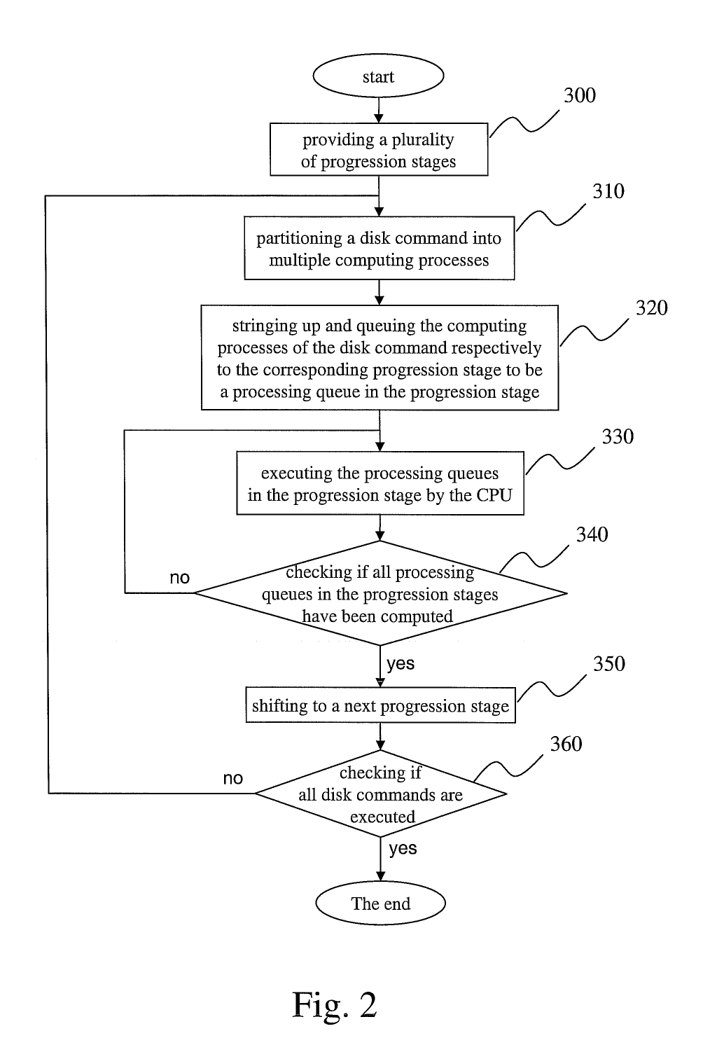

FIG. 2 is a flowchart illustrating steps of the divided disk command processing method of this invention. As shown in FIG. 2, firstly, the CPU 110 provides a plurality of progression stages, 1301˜130n, according to the multiple computing processes of a disk command 200 (Step 300). Then, the CPU 110 executes a disk command 200 having multiple computing processes, 2001˜200n (Step 310). The command queuing unit 120 then strings up and queues the computing process 2001˜200n of the disk command 200 respectively into the corresponding progression stage 1301˜130n to be a processing queue “q” in the progression stage (Step 320). The CPU 110 executes the processing queues queued in the progression stage 1301˜130n (Step 330). Then, the queue checking unit 130 checks one of the progression stages 1301˜130n to find if all the processing queues queued in the progression stage 1301˜130n have been executed (Step 340). If in Step 340, there is still a processing queue in the progression stage 1301 has not been executed by the CPU 110, the procedure stays in Step 330 to execute all the processing queues in the progression stage 1301. But if all the processing queues in the progression stage 1301 are executed in the above-mentioned Step 340, the CPU 110 shifts from the progression stage 1301 to a next progression stage 1302 (Step 350) to execute all the processing queues in the next progression stage 1302. After Step 350, the CPU checks if all disk commands are executed (Step 360). If in Step 360, there is a new disk command to be processed, the procedure goes back to Step 310 to execute the disk command separately by the CPU 110. But if disk commands are all executed in Step 360, the procedure is ended.

Although the present invention has been described in considerable detail with reference certain embodiments thereof, other embodiments are possible. Therefore, their spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A divided disk command processing system, comprising:
a CPU providing a plurality of progression stages to partition a disk command into multiple computing processes and separately executing the computing processes in the progression stages to execute the disk command;
a command queuing unit stringing up and queuing each computing process of the disk command respectively into the corresponding progression stage to become a processing queue in the progression stage for the CPU to execute; and
a queue checking unit checking all processing queues in each of the progression stages to find the processing queue which have not been computed, and informing the CPU to compute the processing queue.

2. The processing system of claim 1, wherein the CPU executes the computing processes being in one identical progression state in each of the progression stages.

3. The processing system of claim 1, wherein the CPU computes all of the processing queues in one of the progression stages, and then shifts to a next progression stage.

4. The processing system of claim 3, wherein the CPU conducts a context twitch when shifting from the progression stage to the next progression stage.

5. The processing system of claim 4, wherein the context switch connotes the CPU suspending progression of executing one process and resuming progression of executing other process that had previously been suspended.

6. A divided disk command processing method, comprising following steps:
providing a plurality of progression stages;
executing a disk command having multiple computing processes;
stringing up and queuing the computing processes of the disk command respectively into the corresponding progression stage to become a processing queue in the progression stage;
executing the computing process of the processing queue which is queued in the progression stage;
checking one of the progression stages to find if all the processing queues in the progression stage have been executed; and
shifting from the progression stage to a next progression stage.

7. The processing method of claim 6, wherein the disk command being executed from one computing process to next computing process comprises a context switch of a CPU.

8. The processing method of claim 7, wherein the context switch connotes the CPU suspending progression of executing one process and resuming progression of executing other process that had previously been suspended.

9. The processing method of claim 6, wherein the CPU executes the computing processes being in one identical progression state in each of the progression stages.

10. The processing method of claim 6, wherein the step of checking one of the progression stages to find if all the processing queues in the progression stage have been executed, further comprises:
shifting from the progression stage to a next progression stage after all processing queues in the progression stage have been computed by the CPU.

11. The processing method of claim 6, wherein the step of shifting from the progression stage to a next progression stage comprises a context switch of the CPU.

12. The processing method of claim 11, wherein the context switch connotes the CPU suspending progression of executing one process and resuming progression of executing other process that had previously been suspended.
